(19) United States
(12) Patent Application Publication
(10) Pub. No.: US 2015/0187290 A1
(43) Pub. Date: Jul. 2, 2015

(54) DISPLAY DEVICE AND DRIVING METHOD THEREOF

(71) Applicant: Samsung Display Co., Ltd., Yongin-City (KR)

(72) Inventors: Sang Yong NO, Asan-si (KR); Sung Hoon KIM, Seoul (KR); Byoung Sun NA, Seoul (KR); Kook Hyun CHOI, Seoul (KR)

(73) Assignee: Samsung Display Co., Ltd., Yongin-City (KR)

(21) Appl. No.: 14/288,076

(22) Filed: May 27, 2014

(30) Foreign Application Priority Data
Dec. 27, 2013 (KR) 10-2013-0166029

(51) Int. Cl. G09G 3/36

(52) U.S. Cl. CPC G09G 3/3607; G09G 3/3614; G09G 3/3659; G09G 2300/0842; G09G 2300/0819; G09G 2320/0247; G09G 2300/0452

(57) ABSTRACT

A display device, includes: a plurality of gate lines which transmits a gate signal; a plurality of data lines which transmits a positive-polarity data voltage and a negative-polarity data voltage; a first color pixel including a first switching element connected to the gate line and the data line and a first capacitor connected to the first switching element, where the first color pixel displays a first color; and a second color pixel including a second switching element connected to the gate line and the data line and a second capacitor connected to the second switching element, where the second color pixel displays a second color different from the first color, where an optimum common voltage of the first color pixel is lower than an optimum common voltage of the second color pixel.

This application claims priority to Korean Patent Application No. 10-2013-0166029 filed on Dec. 27, 2013, and all the benefits accruing therefrom under 35 U.S.C. §119, the content of which in its entirety is herein incorporated by reference.

### BACKGROUND

(a) Field

The invention relates to a display device and a driving method thereof, and more particularly, to a display device with reduced change in color coordinates with the passage of time, and a driving method thereof.

(b) Description of the Related Art

In general, a display device, such as a liquid crystal display (“LCD”) and an organic light emitting diode display, includes a display substrate that includes a plurality of pixels including switching elements and a plurality of signal lines, a data driver for applying a gray voltage corresponding to an input image signal among a plurality of gray voltages to data lines as a data signal, and the like.

The LCD typically includes two display substrates including pixel electrodes and a counter electrode, and a liquid crystal layer interposed therebetween and having dielectric anisotropy. The pixel electrodes may be arranged substantially in a matrix form, and are connected to the switching elements such as thin film transistors (“TFT” s), to receive data voltages sequentially row by row. The counter electrode may be provided all over a surface of a display substrate to receive a common voltage. Voltages are applied to the pixel electrodes and the counter electrode to generate an electric field in the liquid crystal layer. In such an LCD, the intensity of the electric field is controlled, thereby controlling the transmittance of light passing through the liquid crystal layer, to display an image. The luminance of the image displayed by pixels of the display device may vary depending on the difference between the voltage of the pixel electrode and the common voltage of the counter electrode.

In such an LCD, a side visibility may be inferior to a front visibility. In such an LCD, one pixel may be divided into two sub-pixels, to which different voltages are applied, to improve the side visibility.

Respective pixels of the display device may display any one of primary colors, such as three primary colors of red, green and blue, or four primary colors. Desired colors may be recognized through the spatial or temporal sum of the primary colors.

### SUMMARY

Referring to FIG. 1, in a conventional display device including a plurality of pixels displaying a plurality of primary colors, color coordinates of the image displayed, particularly, color coordinates of a low-gray image, may be changed with the passage of driving time. This is called time-dependent change of color coordinates.

Exemplary embodiments of the invention provide a display device having advantages of improving the time-dependent change of color coordinates without deterioration of picture quality due to flicker at the time of driving the display device, and a driving method thereof.

An exemplary embodiment of the invention provides a display device including: a plurality of gate lines which transmits a gate signal; a plurality of data lines which transmits a positive-polarity data voltage and a negative-polarity data voltage; a first color pixel including a first switching element connected to the gate line and the data line and a first capacitor connected to the first switching element, where the first color pixel displays a first color; and a second color pixel including a second switching element connected to the gate line and the data line and a second capacitor connected to the second switching element, where the second color pixel displays a second color different from the first color, in which an optimum common voltage of the first color pixel is lower than an optimum common voltage of the second color pixel.

In an exemplary embodiment, a first kickback voltage of the first color pixel may be greater than a second kickback voltage of the second color pixel.

In an exemplary embodiment, a capacitance of a first parasitic capacitor between a drain electrode and a gate electrode of the first switching element may be greater than a capacitance of a second parasitic capacitor between a drain electrode and a gate electrode of the second switching element.

In an exemplary embodiment, an area of the gate electrode of the first switching element may be larger than an area of the gate electrode of the second switching element.

In an exemplary embodiment, the first capacitor may include: a first liquid crystal capacitor including a first pixel electrode connected to a drain electrode of the first switching element and a counter electrode, as two terminals thereof; and a first storage capacitor including the first pixel electrode or the drain electrode of the first switching element, and a first storage electrode, as two terminals thereof. In such an embodiment, the second capacitor may include: a second liquid crystal capacitor including a second pixel electrode connected to a drain electrode of the second switching element and a counter electrode as two terminals thereof; and a second storage capacitor including the second pixel electrode or the drain electrode of the second switching element, and a second storage electrode, as two terminals thereof.

In an exemplary embodiment, a capacitance of the first storage capacitor may be less than a capacitance of the second storage capacitor.

In an exemplary embodiment, a capacitance of the first liquid crystal capacitor may be less than a capacitance of the second liquid crystal capacitor.

In an exemplary embodiment, a first central value of the positive-polarity data voltage and the negative-polarity data voltage, which are input to the first color pixel, may be lower than a second central value of the positive-polarity data voltage and the negative-polarity data voltage, which are input to the second color pixel.

In an exemplary embodiment, the first color may include a blue color.

In an exemplary embodiment, each of the first color pixel and the second color pixel may include a first sub-pixel and a second sub-pixel, which display an image based on different gamma curves from each other, where the first sub-pixel of the first color pixel may include the first switching element, the first sub-pixel of the second color pixel may include the second switching element, and an optimum common voltage of the first sub-pixel of the first color pixel may be lower than an optimum common voltage of the first sub-pixel of the second color pixel.

In an exemplary embodiment, a first kickback voltage of the first sub-pixel of the first color pixel may be greater than a second kickback voltage of the first sub-pixel of the second color pixel.

In an exemplary embodiment, a capacitance of a first parasitic capacitor between a drain electrode and a gate electrode of the first switching element may be greater than a capacitance of a second parasitic capacitor between a drain electrode and a gate electrode of the second switching element.

In an exemplary embodiment, an area of the gate electrode of the first switching element may be larger than an area of the gate electrode of the second switching element.

In an exemplary embodiment, the first capacitor may include: a first liquid crystal capacitor including a first sub-pixel electrode connected to a drain electrode of the first switching element and a counter electrode, as two terminals thereof; and a first storage capacitor including the first sub-pixel electrode or the drain electrode of the first switching element, and a first storage electrode, as two terminals thereof. In such an embodiment, the second capacitor may include: a second liquid crystal capacitor including a second sub-pixel electrode connected to a drain electrode of the second switching element and a counter electrode, as two terminals thereof; and a second storage capacitor including the second sub-pixel electrode or the drain electrode of the second switching element, and a second storage electrode, as two terminals thereof.

In an exemplary embodiment, a capacitance of the first storage capacitor may be less than a capacitance of the second storage capacitor.

In an exemplary embodiment, a capacitance of the first liquid crystal capacitor may be less than a capacitance of the second liquid crystal capacitor.

In an exemplary embodiment, a first central value of the positive-polarity data voltage and the negative-polarity data voltage, which are input to the first sub-pixel of the first color pixel, may be lower than a second central value of the positive-polarity data voltage and the negative-polarity data voltage, which are input to the first sub-pixel of the second color pixel.

In an exemplary embodiment, a common voltage applied to the first color pixel and the second color pixel may be substantially constant.

Another embodiment of the invention provides a driving method of a display device including: turning on a first switching element in a first color pixel of the display device to charge a first capacitor in the first color pixel, where the first color pixel displays a first color and the first capacitor is connected to the first switching element; turning on a second switching element in a second color pixel of the display device to charge a second capacitor in the second color pixel, where the second color pixel displays a second color different from the first color, and the second capacitor is connected to the second switching element; turning off the first switching element to drop a voltage of a first pixel electrode in the first color pixel by a first kickback voltage; and turning off the second switching element to drop a voltage of a second pixel electrode in the second color pixel by a second kickback voltage, where the first kickback voltage is greater than the second kickback voltage.

Yet another embodiment of the invention provides a driving method of a display device including: applying a positive-polarity data voltage and a negative-polarity data voltage to a first color pixel of the display device through a first switching element in the first color pixel while the first switching element is turned on; and applying a positive-polarity data voltage and a negative-polarity data voltage to a second color pixel of the display device through a second switching element in the second color pixel while the second switching element is turned on, where a first central value of the positive-polarity data voltage and the negative-polarity data voltage that are input to the first color pixel, is lower than a second central value of the positive-polarity data voltage and the negative-polarity data voltage that are input to the second color pixel.

According to exemplary embodiments of the invention, when a display device including a plurality of pixels displaying a plurality of primary colors is driven, the time-dependent change of color coordinates in the image displayed with the passage of driving time can be improved without deterioration of picture quality due to flicker.

### BRIEF DESCRIPTION OF THE DRAWINGS

The above and other features of the invention will become more apparent by describing in detailed exemplary embodiments thereof with reference to the accompanying drawings, in which:

FIG. 1 is a graph showing color coordinate changes for multiple driving times in a conventional display device;

FIG. 2 shows pixels displaying different primary colors, which are included in an exemplary embodiment of a display device according to the invention;

FIG. 3 is a schematic circuit diagram of one pixel in an exemplary embodiment of a display device according to the invention;

FIG. 4 is a graph showing luminance change depending on a common voltage in a first color pixel of an exemplary embodiment of a display device according to an exemplary embodiment of the invention;

FIG. 5 is a graph showing luminance change depending on a common voltage in a first color pixel of an exemplary embodiment of a display device according to the invention;

FIG. 6 is a graph showing color coordinate changes depending on a common voltage and driving time in a conventional display device;

FIG. 7 is a graph showing color coordinate changes depending on the common voltage and the driving time in an exemplary embodiment of a display device according to the invention;

FIGS. 8 to 13 illustrate graphs showing color coordinate changes and time-dependent changes of color coordinates in exemplary embodiments of a display device, in which the optimum common voltages of the first color pixel is variously set, according to the invention;

FIG. 14 is a schematic circuit diagram of a first color pixel in an exemplary embodiment of a display device according to the invention;

FIG. 15 is a schematic circuit diagram of a second color pixel in an exemplary embodiment of a display device according to the invention;

FIG. 16 is a graph showing gamma curves of the image shown by two sub-pixels included in one pixel of an exemplary embodiment of a display device according to the invention;

FIG. 17 is a plan view of a pixel displaying a second color in an exemplary embodiment of a display device according to the invention;

FIG. 18 is a cross-sectional view taken along line XVIII-XVIII of the display device of FIG. 17;

FIG. 19 is a plan view of a first color pixel in an exemplary embodiment of a display device according to the invention;

FIG. 20 is a plan view of a second color pixel in an exemplary embodiment of a display device according to the invention;

FIG. 21 is a plan view of a first color pixel in an exemplary embodiment of a display device according to the invention;

FIG. 22 is a plan view of a second color pixel in an exemplary embodiment of a display device according to the invention;

FIG. 23 is a plan view of a first color pixel in an exemplary embodiment of a display device according to the invention;

FIG. 24 is a graph showing levels of data voltages depending on grayscale levels while the data voltages are applied to a first color pixel and a second color pixel in an exemplary embodiment of a display device according to the invention;

FIG. 25 is a schematic circuit diagram of a first color pixel in an exemplary embodiment of a display device according to the invention;

FIG. 26 is a schematic circuit diagram of a second color pixel in an exemplary embodiment of a display device according to the invention;

FIG. 27 is a schematic circuit diagram of a first color pixel in an exemplary embodiment of a display device according to the invention; and

FIG. 28 is a schematic circuit diagram of a second color pixel in an exemplary embodiment of a display device according to the invention.

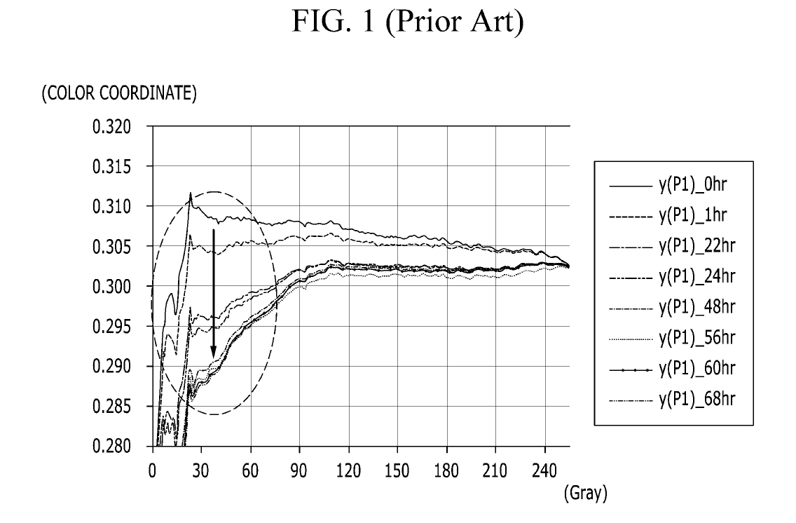

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims.

Hereinafter, exemplary embodiments of a display device and exemplary embodiments of a driving method thereof, according to the invention, will be described in detail with reference to the accompanying drawings.

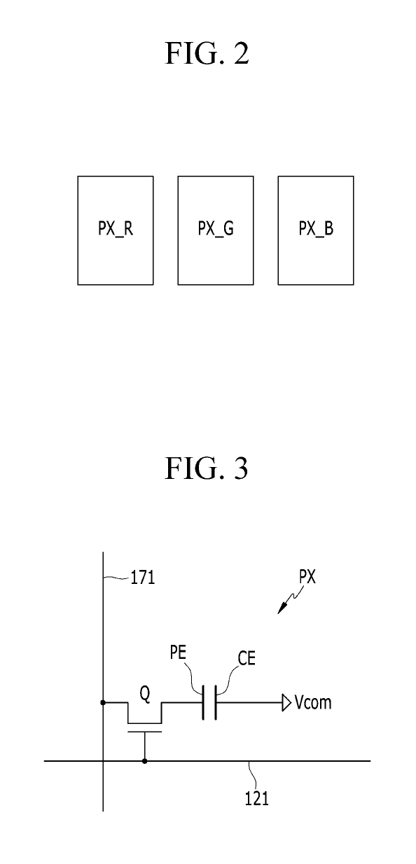

First, exemplary embodiments of a display device according to the invention will be described with reference to FIGS. 2 to 13.

FIG. 2 shows pixels displaying different primary colors, which are included in an exemplary embodiment of a display device according to the invention, and FIG. 3 is a schematic circuit diagram of one pixel in an exemplary embodiment of a display device according to the invention.

Referring to FIGS. 2 and 3, an exemplary embodiment of a display device includes a plurality of pixels PX and a plurality of signal lines.

The plurality of signal lines includes a plurality of gate lines 121 that transmits a gate signal and a plurality of data lines 171 that transmits data voltages.

Each of the plurality of pixels may display one of primary colors. In one exemplary embodiment, for example, each of the pixels PX displays one of primary colors (spatial division), or each of the pixels PX alternately displays primary colors according to time (temporal division), such that a desired color may be recognized by the temporal or spatial sum of the primary colors. In an exemplary embodiment, the primary colors may be three primary colors, such as red, green and blue, for example, or four primary colors. In such an embodiment, each of the pixels PX may include a color filter for displaying a corresponding primary color or receive light having the corresponding primary color. In an exemplary embodiment, as shown in FIG. 2, the pixels PX may include a red pixel PX_R that displays red, a green pixel PX_G that displays green, and a blue pixel PX_B that displays blue, but they are not limited thereto.

The plurality of pixels PX may include a first color pixel and a second color pixel that displays a different color from the first color pixel. In an exemplary embodiment, the first color may be blue and the second color may be another primary color other than blue, e.g., red or green, but the first color and the second color are not limited thereto. In an exemplary embodiment, a color having the lowest visibility may be selected as the first color from the plurality of primary colors.

Referring to FIG. 3, one pixel PX included in an exemplary embodiment of the display device includes a switching element Q connected to a data line 171 and a gate line 121, a pixel electrode PE connected thereto, and a counter electrode CE disposed opposite to the pixel electrode PE and which receives a common voltage (Vcom). The switching element Q may include a thin film transistor. The switching element Q may transmit a data voltage transmitted from the data line 171 to the pixel electrode PE under the control of the gate signal transmitted from the gate line 121.

In an exemplary embodiment, where the display device is a liquid crystal display device, one pixel PX, when viewed from a cross-sectional view, may include lower and upper display substrates (not shown) facing each other and a liquid crystal layer (not shown) interposed therebetween.

Now, operations of such an embodiment of the display device will be described.

When a data voltage is generated in response to an image signal and a control signal, which are input from the outside, the data voltage is applied to a corresponding data line 171. The image signal contains luminance information of each pixel PX. The luminance information has a predetermined number of grayscale levels, for example, 1024 (=2¹⁰), 256 (=2⁸) or 64 (=2⁶) grayscale levels.

When a gate-on voltage, that is, a voltage capable of turning on the switching element Q, is applied to the gate line 121, the switching element Q connected to the gate line 121 is turned on. Then, the data voltage applied to the data lines 171 is applied to a corresponding pixel PX through the turned-on switching element Q.

The difference between the data voltage applied to each pixel electrode PE of the pixel PX and the common voltage (Vcom) applied to the counter electrode CE is expressed as or defines a pixel voltage. In an exemplary embodiment, where the display device is the liquid crystal display, liquid crystal molecules in a liquid crystal layer are differently arranged depending on the pixel voltage level, such that the polarization of the light passing through the liquid crystal layer 3 may be changed. The change in polarization is expressed as a change in light transmittance, through which the pixel PX displays the luminance expressed by the grayscale level of the image signal.

This procedure is repeated every horizontal period, such that the gate-on voltage Von is applied to all of the gate lines 121 and the data voltage is applied to all of the pixels PX, thereby displaying one frame of image. When displaying one frame of image ends, the following frame starts. Here, based on the common voltage (Vcom), the polarity of the data voltage applied to each pixel PX may be controlled to be inverted from the polarity of the data voltage in the previous frame. The data voltage having a positive polarity with respect to the common voltage (Vcom) is referred to as a positive-polarity data voltage, and the data voltage having a negative polarity with respect to the common voltage (Vcom) is referred to as a negative-polarity data voltage.

When the common voltage (Vcom) applied to the counter electrode CE of the pixel PX is set to a predetermined common voltage, e.g., an optimum common voltage, for each grayscale level, the occurrence of flicker due to the polarity reverse driving of data voltage may be minimized. The optimum common voltage may be a common voltage level at which the luminance of the image is minimized for each grayscale level, particularly in a low-gray image signal. The optimum common voltage may have approximately a central value between the positive-polarity data voltage and the negative-polarity data voltage for each grayscale level.

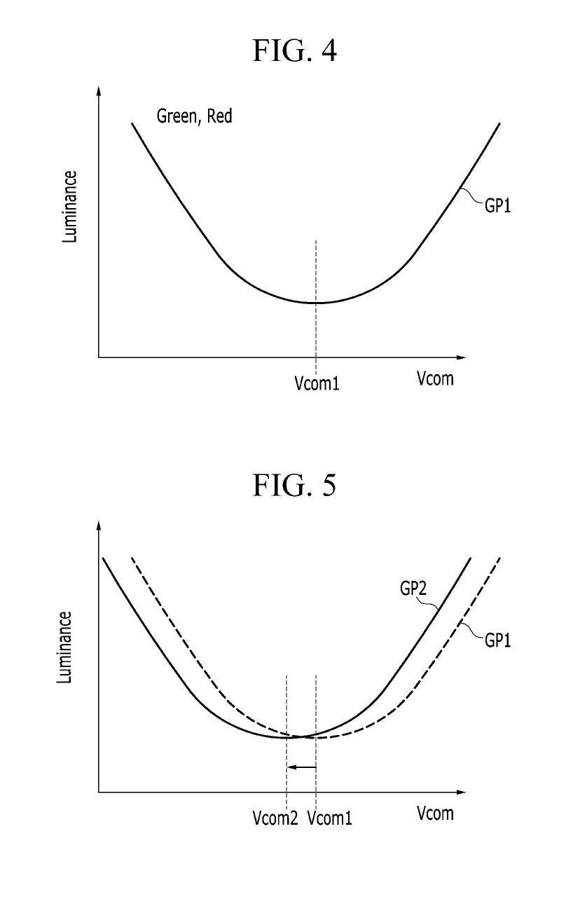

FIG. 4 is a graph (GP1) showing the luminance versus the common voltage (Vcom) when a pixel PX for displaying a second color, for example, a primary color except for blue, that is, green or red, displays a low-gray image having a grayscale level of approximately 30, for example. The optimum common voltage (Vcom1) of the pixel PX for displaying the second color, for example, a primary color except for blue, may be a common voltage (Vcom) when the luminance of the image is the smallest.

FIG. 5 is a graph (GP2) showing the luminance versus the common voltage (Vcom) when a first color pixel, for example, a blue color pixel PX_B, displays a low-gray image having a grayscale level of approximately 30, for example. The optimum common voltage (Vcom2) of the first color pixel, for example, a blue color pixel PX_B, may be a common voltage (Vcom) when the luminance of the image is the smallest. According to an exemplary embodiment of the invention, the optimum common voltage (Vcom2) of the first color pixel is different from, for example, lower than, the optimum common voltage (Vcom1) of the second color pixel.

In an exemplary embodiment, the first color pixel and the second color pixel may have different structures, or the data voltages applied to the first color pixel and the second color pixel may be adjusted, to allow the optimum common voltage (Vcom2) of the first color pixel to be different from the optimum common voltage (Vcom1) of the second color pixel. Such an embodiment will be described later in detail.

In an exemplary embodiment, the optimum common voltage (Vcom2) of the first color pixel may be lower than the optimum common voltage (Vcom1) of the second color pixel by approximately 0.1 volt (V) to approximately 0.6 V, but is not limited thereto.

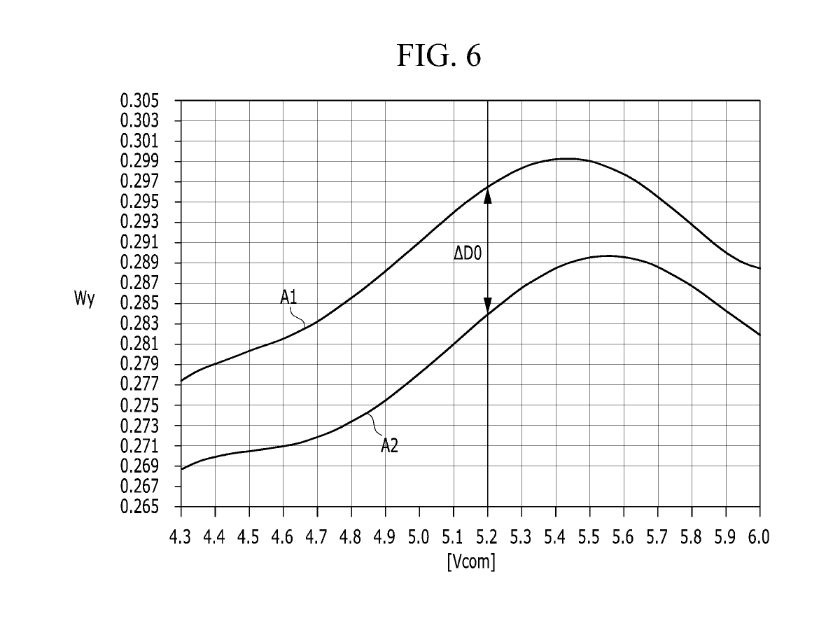

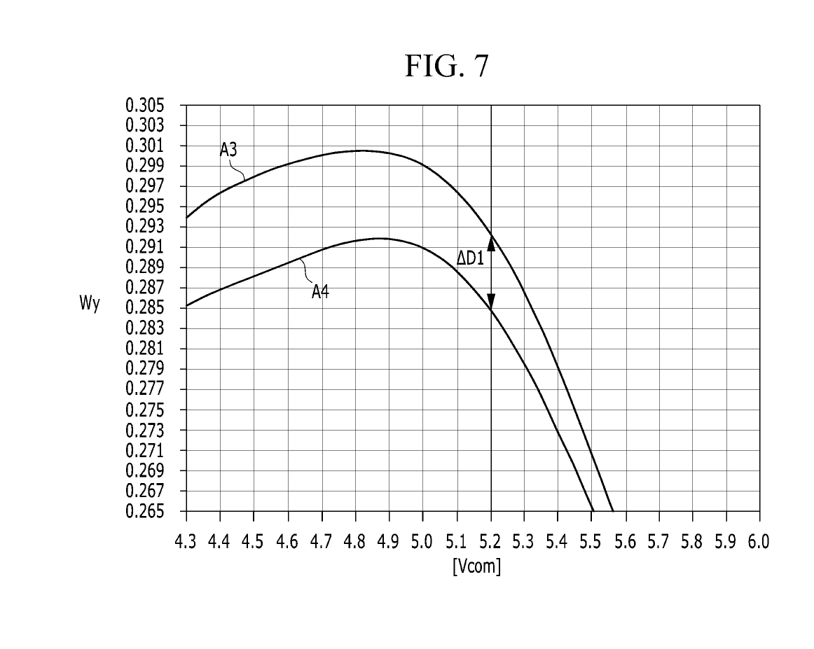

FIG. 6 is a graph showing color coordinate changes depending on the common voltage and the driving time in a display device according to the conventional art, and FIG. 7 is a graph showing color coordinate changes depending on the common voltage and the driving time in an exemplary embodiment of a display device according to the invention.

When the optimum common voltage of the first color pixel, for example, a blue color pixel PX_B, is substantially the same as the optimum common voltage of the second color pixel as in the conventional art, the color coordinate of the image displayed when the common voltage (Vcom) applied to the counter electrode CE has a predetermined voltage level (for example, approximately 5.2 V) is changed from curve A1 to curve A2 with the passage of time, as shown in FIG. 6. The y-coordinate (Wy) of white or a shade of gray on the 1931 CIE XYZ color coordinate system may be reduced with the passage of driving time of the display device.

Hereafter, the color coordinate means a y-coordinate (Wy) on the 1931 CIE XYZ color coordinate system, and the change of color coordinate with the passage of time is referred to as a time-dependent change of color coordinate.

In an exemplary embodiment of the invention, as shown in FIG. 7, the color coordinate of the image displayed for a predetermined common voltage (Vcom, for example, approximately 5.2 V) is changed from curve A3 to curve A4 with the passage of the driving time. FIG. 7 shows the time-dependent change of color coordinate when the optimum common voltage (Vcom2) of the first color pixel, for example, a blue color pixel PX_B is set to be different from, for example, approximately 0.15 V lower than the optimum common voltage (Vcom1)) of the second color pixel.

As shown in FIGS. 6 and 7, in an exemplary embodiment of a display device where the optimum common voltage (Vcom2) of the first color pixel is different from the optimum common voltage (Vcom1)) of the second color pixel, the time-dependent change of the color coordinate (ΔD1) is smaller than the reference time-dependent change of the color coordinate (ΔD0) in the display device according to the conventional art as shown in FIG. 6.

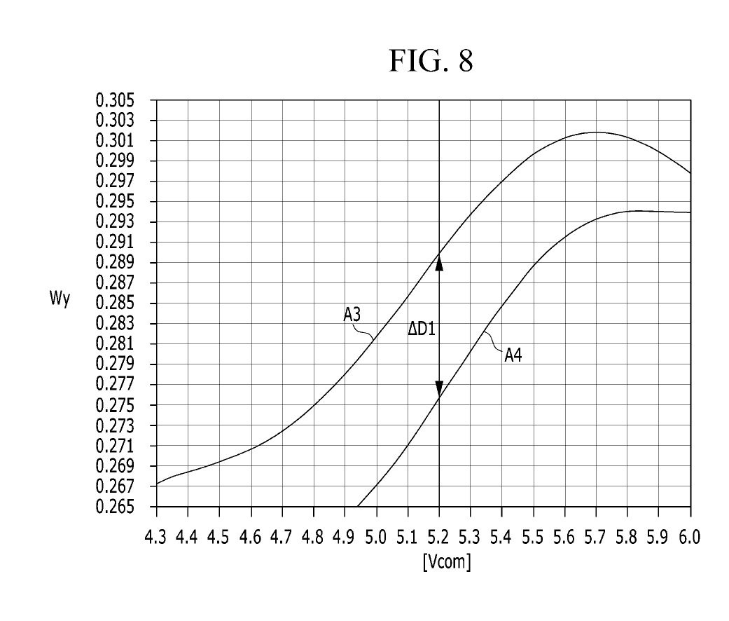

In an exemplary embodiment, the lower the optimum common voltage (Vcom2) of the first color pixel, the smaller the time-dependent change of the color coordinate (ΔD1) as compared with the optimum common voltage (Vcom1) of the second color pixel. This will hereinafter be described with reference to FIGS. 8 to 13.

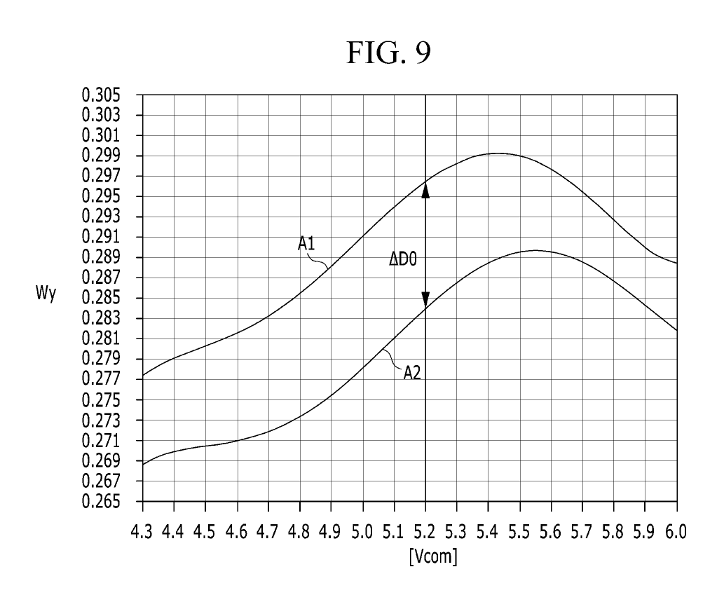

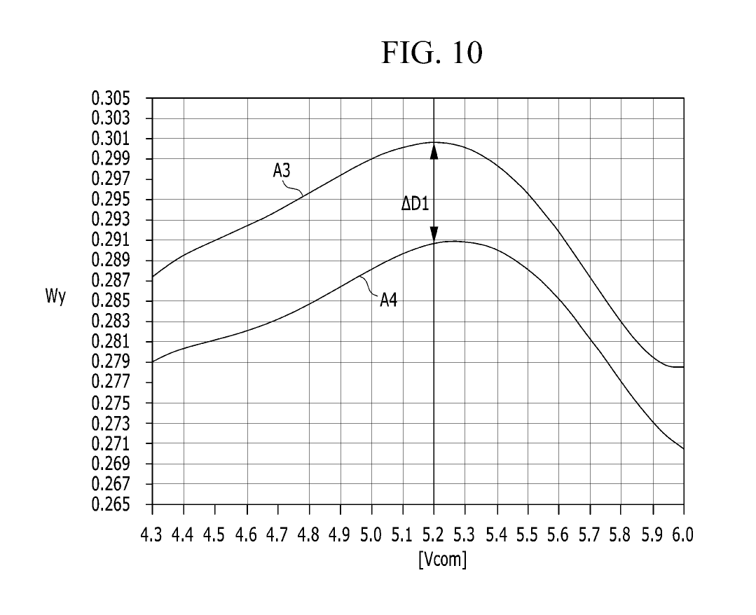

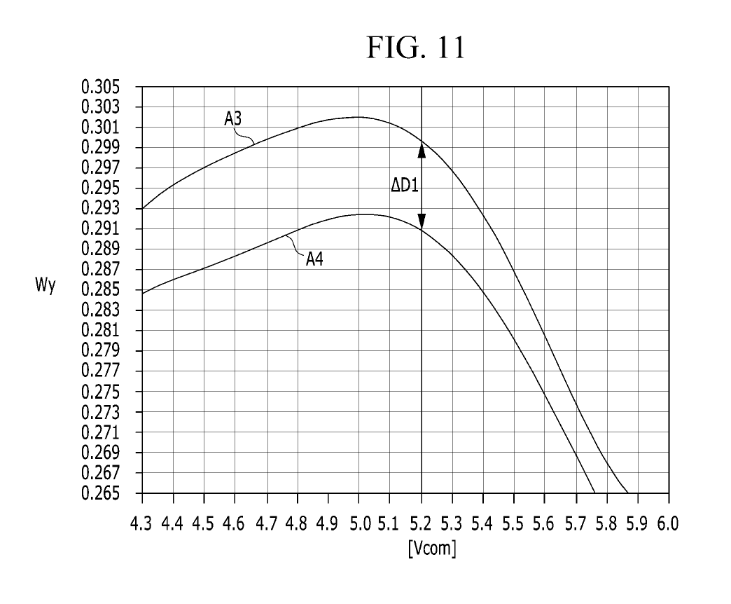

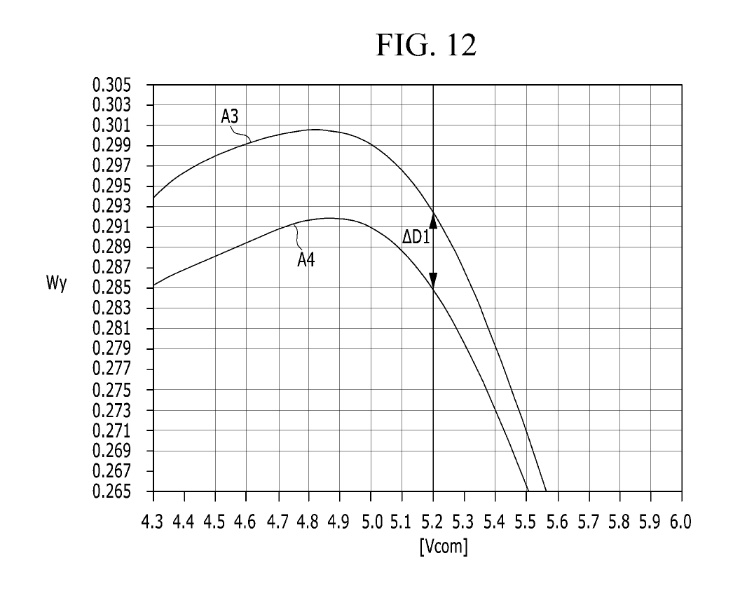

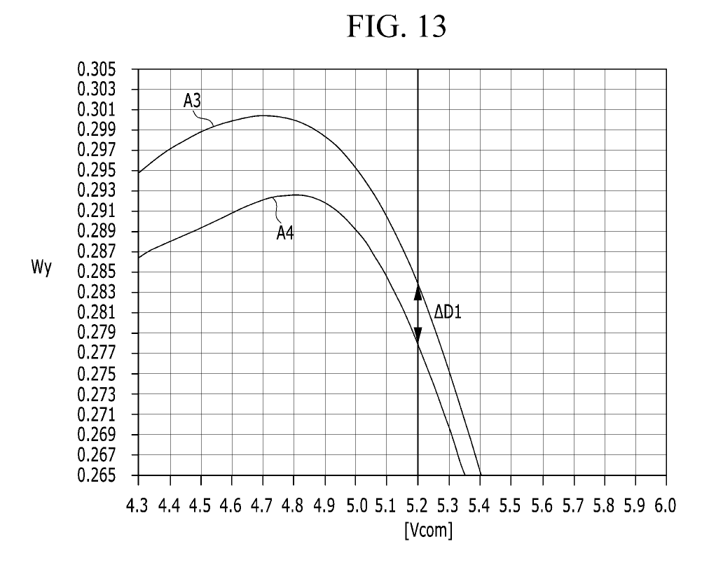

FIGS. 8 to 13 illustrate graphs showing color coordinate changes and time-dependent changes of the color coordinate in exemplary embodiments of a display device, in which the optimum common voltages of the first color pixel is variously set, according to the invention. FIG. 8 shows an exemplary embodiment, where the optimum common voltage (Vcom2) of the first color pixel is approximately 0.05 V lower than the optimum common voltage (Vcom1) of the second color pixel, FIG. 9 is for an exemplary embodiment, where the optimum common voltage (Vcom2) of the first color pixel is the same as the optimum common voltage (Vcom1) of the second color pixel, and FIG. 10 is for an exemplary embodiment, where the optimum common voltage (Vcom2) of the first color pixel is approximately 0.05 V higher than the optimum common voltage (Vcom1) of the second color pixel. FIG. 11 is for an exemplary embodiment, where the optimum common voltage (Vcom2) of the first color pixel is approximately 0.10 V lower than the optimum common voltage (Vcom1) of the second color pixel, FIG. 12 is for an exemplary embodiment, where the optimum common voltage (Vcom2) of the first color pixel is approximately 0.15 V lower than the optimum common voltage (Vcom1) of the second color pixel, and FIG. 13 is for an exemplary embodiment, where the optimum common voltage (Vcom2) of the first color pixel is approximately 0.20 V lower than the optimum common voltage (Vcom1) of the second color pixel.

The time-dependent change of color coordinate (ΔD1) in FIG. 8 tends to be greater than the reference time-dependent change of the color coordinate (ΔD0) when the optimum common voltage (Vcom2) is substantially the same as the optimum common voltage (Vcom1) shown in FIG. 9. The time-dependent change of the color coordinate (ΔD1) in FIG. 8 may be approximately 112.4% of the reference time-dependent change of the color coordinate (ΔD0) in FIG. 9.

As shown in FIGS. 10 to 13, in an exemplary embodiment, where the optimum common voltage (Vcom2) of the first color pixel is lower than the optimum common voltage (Vcom1) of the second color pixel, as the difference between the optimum common voltage (Vcom2) of the first color pixel and the optimum common voltage (Vcom1) of the second color pixel increases, the time-dependent change of the color coordinate (ΔD1) becomes gradually smaller than the reference time-dependent change of the color coordinate (ΔD0). The time-dependent change of the color coordinate (ΔD1) in an exemplary embodiment shown in FIG. 10 may be approximately 80.6% of the reference time-dependent change of the color coordinate (ΔD0), the time-dependent change of the color coordinate (ΔD1) in an exemplary embodiment shown in FIG. 11 may be approximately 71.5% of the reference time-dependent change of the color coordinate (ΔD0), the time-dependent change of the color coordinate (ΔD1) in an exemplary embodiment shown in FIG. 12 may be approximately 61.1% of the reference time-dependent change of the color coordinate (ΔD0), and the time-dependent change of the color coordinate (ΔD1) in an exemplary embodiment shown in FIG. 13 may be approximately 46.3% of the reference time-dependent change of the color coordinate (ΔD0). In such an embodiment, as the amount by which the optimum common voltage (Vcom2) of the first color pixel, for example, a blue pixel PX_B, is lower than the optimum common voltage (Vcom1), is increased, the curve of the color coordinate (Wy) with respect to the common voltage (Vcom) at the low gray (for example, a grayscale level of 30) may be shifted to the left, and thus the time-dependent change of the color coordinate (ΔD1) is reduced.

As described above, in an exemplary embodiment, when the optimum common voltage (Vcom2) of the first color pixel, for example, a blue pixel PX_B, is lower than the optimum common voltage (Vcom1) of the second color pixel, the time-dependent change of the color coordinate (ΔD1) may be reduced, such that the change of color coordinate with the passage of driving time of the display device may be reduced. In such an embodiment, since only the optimum common voltage (Vcom2) of the first color pixel is changed while the common voltage (Vcom), which is set to minimize flicker, is not changed, the horizontal crosstalk and flicker due to the change of common voltage may not occur. In such an embodiment, since the first color is set to a primary color such as blue, which has the lowest degree of visibility among a plurality of primary colors, the flicker phenomenon due to the change of the optimum common voltage (Vcom2) of the first color pixel may be effectively prevented or substantially minimized from being recognized.

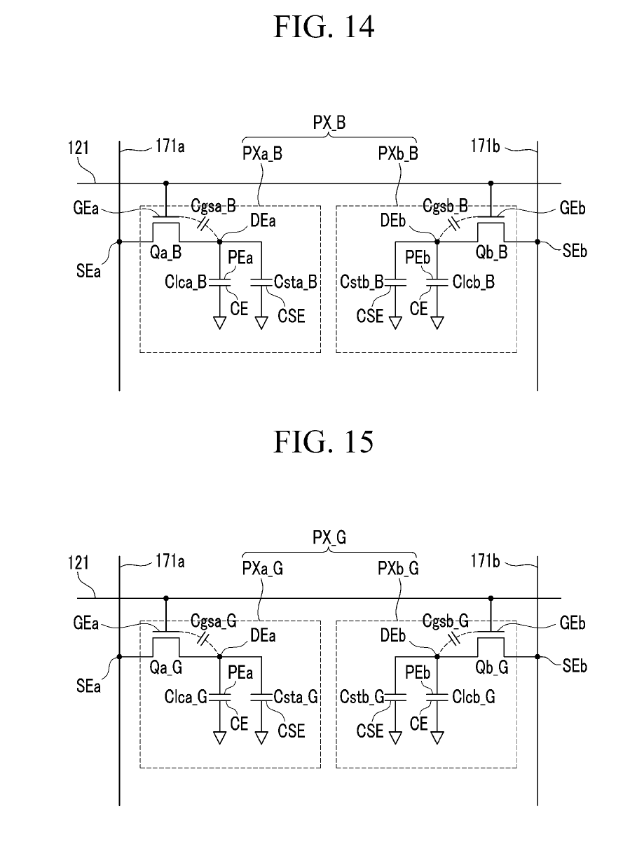

Now, a structure and method for making the optimum common voltage (Vcom2) of the first color pixel, for example, a blue pixel PX_B, be different from the optimum common voltage (Vcom1) of the second color pixel, for example, a pixel showing a primary color except blue in an exemplary embodiment of the display device according to the invention, will be described with reference to FIGS. 14 to 16.

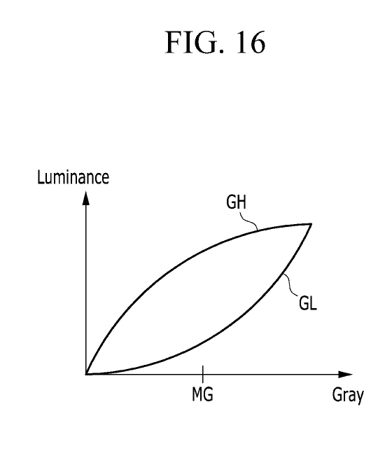

FIG. 14 is a schematic circuit diagram of a first color pixel in an exemplary embodiment of a display device according to the invention, FIG. 15 is a schematic circuit diagram of a second color pixel in an exemplary embodiment of a display device according to the invention, and FIG. 16 is a graph showing gamma curves of the image shown by two sub-pixels included in one pixel of an exemplary embodiment of a display device according to the invention.

Referring to FIGS. 14 and 15, an exemplary embodiment of a display device according to the invention includes first and second data lines 171a and 171b that transmit data voltages, and a gate line 121 that transmits a gate signal.

Referring to FIG. 14, the first color pixel may be, for example, a blue pixel PX_B, and may include first and second sub-pixels PXa_B and PXb_B. The first sub-pixel PXa_B of the first color pixel may include a first switching element Qa_B, a first liquid crystal capacitor Clca_B and a first storage capacitor Csta_B, and the second sub-pixel PXb_B of the first color pixel may include a second switching element Qb_B, a second liquid crystal capacitor Clcb_B and a second storage capacitor Cstb_B.

The first switching element Qa_B of the first color pixel includes a gate electrode GEa connected to the gate line 121 and a source electrode SEa connected to the first data line 171a. A drain electrode DEa of the first switching element Qa_B is connected to the first liquid crystal capacitor Clca_B and the first storage capacitor Csta_B. The gate electrode GEa and the drain electrode DEa of the first switching element Qa_B may form a parasitic capacitor Cgsa_B.

The first liquid crystal capacitor Clca_B of the first color pixel includes a first sub-pixel electrode PEa and a counter electrode CE as two terminals thereof. The first storage capacitor Csta_B includes the first sub-pixel electrode PEa or the drain electrode DEa of the first switching element Qa_B and a storage electrode CSE as two terminals thereof.

The second switching element Qb_B of the first color pixel includes a gate electrode GEb connected to the gate line 121 and a source electrode SEb connected to the second data line 171b. A drain electrode DEb of the second switching element Qb_B is connected to the second liquid crystal capacitor Clcb_B and the second storage capacitor Cstb_B. The gate electrode GEb and the drain electrode DEb of the second switching element Qb_B may form a parasitic capacitor Cgsb_B.

The second liquid crystal capacitor Clcb_B of the first color pixel includes a second sub-pixel electrode PEb and the counter electrode CE as two terminals thereof. The second storage capacitor Cstb_B of the first color pixel includes the second sub-pixel electrode PEb or the drain electrode DEb of the second switching element Qb_B and the storage electrode CSE as two terminals thereof.

The first liquid crystal capacitor Clca_B and the second liquid crystal capacitor Clcb_B of the first color pixel may receive substantially a same data voltage as or different voltages from each other for a same image signal through the first and second switching elements Qa_B and Qb_B connected to different data lines 171a and 171b.

Referring to FIG. 15, the second color pixel may be, for example, a green pixel PX_G. The green pixel PX_G may include first and second sub-pixels PXa_G and PXb_G. The first sub-pixel PXa_G of the second color pixel may include a first switching element Qa_G, a first liquid crystal capacitor Clca_G and a first storage capacitor Csta_G, and the second sub-pixel PXb_G of the second color pixel may include a second switching element Qb_G, a second liquid crystal capacitor Clcb_G and a second storage capacitor Cstb_G.

The first switching element Qa_G of the second color pixel includes a gate electrode GEa connected to the gate line 121 and a source electrode SEa connected to the first data line 171a. A drain electrode DEa of the first switching element Qa_G is connected to the first liquid crystal capacitor Clca_G and the first storage capacitor Csta_G. The gate electrode GEa and the drain electrode DEa of the second switching element Qa_G may form a parasitic capacitor Cgsa_G.

The first liquid crystal capacitor Clca_G of the second color pixel includes a first sub-pixel electrode PEa and a counter electrode CE as two terminals thereof. The first storage capacitor Csta_G of the second color pixel includes the first sub-pixel electrode PEa or the drain electrode DEa of the first switching element Qa_G and a storage electrode CSE as two terminals thereof.

The second switching element Qb_G of the second color pixel includes a gate electrode GEb connected to the gate line 121 and a source electrode SEb connected to the second data line 171b. A drain electrode DEb of the second switching element Qb_G is connected to the second liquid crystal capacitor Clcb_G and the second storage capacitor Cstb_G. The gate electrode GEb and the drain electrode DEb of the second switching element Qb_G may form a parasitic capacitor Cgsb_G.

The second liquid crystal capacitor Clcb_G of the second color pixel includes a second sub-pixel electrode PEb and the counter electrode CE as two terminals thereof. The second storage capacitor Cstb_G of the second color pixel includes the second sub-pixel electrode PEb or the drain electrode DEb of the second switching element Qb_G and the storage electrode CSE as two terminals thereof.

The first liquid crystal capacitor Clca_G and the second liquid crystal capacitor Clcb_G of the second color pixel may receive substantially a same data voltage as or different voltages from each other for a same image signal through the first and second switching elements Qa_G and Qb_G connected to different data lines 171a and 171b.

In an alternative exemplary embodiment, the second color pixel may be a red pixel PX_R, which may have a structure substantially the same as the structure shown in FIG. 15.

The first sub-pixel PXa_B or PXa_G and the second sub-pixels PXb_B or PXb_G included in one pixel as shown in FIG. 14 or 15 may display an image based on different gamma curves GH and GL. In an exemplary embodiment, the high gamma curve (GH) that the first sub-pixel PXa_B or PXa_G follows may be generally dominant in the low-gray region based on the median gray (MG). The gamma curves (GH and GL) may be adjusted such that the synthetic curve at the front of two gamma curves (GH and GL) is substantially the same as a front gamma curve (for example, a gamma curve having a gamma value of 2.2) set to be most suitable for the display device, and the synthetic curve at the side is substantially close, e.g., as close as possible, to the front gamma curve.

Referring to FIGS. 14 and 15, in an exemplary embodiment, to set the optimum common voltage (Vcom2) of the first color pixel to be different from the optimum common voltage (Vcom1) of the second color pixel, the first color pixel and the second color pixel may be configured to set the kickback voltage of the first color pixel to be different from the kickback voltage of the second color pixel. Here, when a data voltage is applied to a pixel electrode or a drain electrode through the switching element that is turned on by application of a gate-on voltage to a gate electrode, and then a gate-off voltage is applied to the gate electrode of the switching element to drop the voltage of the pixel electrode or the drain electrode, the dropped voltage difference is herein referred to as the kickback voltage.

The kickback voltage (Vkb) of each of the pixels or each of the sub-pixels PXa_B, PXa_G, PXb_B and PXb_G may be determined by Equation 1 below.

Vkb=Cgs/(Clc+Cgs+Cst) Equation 1:

In Equation 1, ‘Cgs’ denotes capacitance of a parasitic capacitor between a gate electrode and a drain electrode of each of switching elements Qa_B, Qa_G, Qb_B and Qb_G of sub-pixels PXa_B, PXa_G, PXb_B and PXb_G, ‘Clc’ denotes capacitance of a liquid crystal capacitor of each of sub-pixels PXa_B, PXa_G, PXb_B and PXb_G, and ‘Cst’ denotes capacitance of a storage capacitor of each of sub-pixels PXa_B, PXa_G, PXb_B and PXb_G.

In one exemplary embodiment, for example, to set the kickback voltage of the first color pixel to be different from the kickback voltage of the second color pixel, the capacitance of at least one of the parasitic capacitors Cgsa_B and Cgsb_B between the gate and drain of the switching elements Qa_B and Qb_B of the first color pixel may be set to be different from the capacitance of the corresponding one of the parasitic capacitors Cgsa_G and Cgsb_G between the gate and drain of the switching elements Qa_G and Qb_G of the second color pixel. In an alternative exemplary embodiment, the capacitance of at least one of the storage capacitors Csta_B and Cstb_B of the first color pixel may be set to be different from the capacitance of the corresponding one of the storage capacitors Csta_G and Cstb_G of the second color pixel. In another alternative exemplary embodiment, the capacitance of at least one of the liquid crystal capacitors Clca_B and Clcb_B of the first color pixel may be set to be different from the capacitance of the corresponding one of the liquid crystal capacitors Clca_G and Clcb_G of the second color pixel.

In such an embodiment, the kickback voltage of the first color pixel is set to be greater than the kickback voltage of the second color pixel, such that the optimum common voltage (Vcom2) of the first color pixel may become lower than the optimum common voltage (Vcom1) of the second color pixel. In such an embodiment, the capacitance of at least one of the parasitic capacitors Cgsa_B and Cgsb_B between the gate and drain of the switching elements Qa_B and Qb_B of the first color pixel may be set to be greater than the capacitance of the corresponding one of the parasitic capacitors Cgsa_G and Cgsb_G between the gate and drain of the switching elements Qa_G and Qb_G of the second color pixel. Alternatively, the capacitance of at least one of the storage capacitors Csta_B and Cstb_B of the first color pixel may be set to be less than the capacitance of the corresponding one of the storage capacitors Csta_G and Cstb_G of the second color pixel. Alternatively, the capacitance of at least one of the liquid crystal capacitors Clca_B and Clcb_B of the first color pixel may be set to be less than the capacitance of the corresponding one of the liquid crystal capacitors Clca_G and Clcb_G of the second color pixel.

In an exemplary embodiment, the time-dependent change of the color coordinate is largely shown mainly in a low-gray region. Therefore, when one pixel PX includes two or more sub-pixels that follow different gamma curves, the kickback voltage of the first sub-pixel PXa_B, which is more dominant in the low-gray region, between the first and second sub-pixels PXa_B and PXb_B of the first color pixel, is set to be greater than the kickback voltage of the first sub-pixel PXa_G of the second color pixel, such that the optimum common voltage (Vcom2) of the first color pixel may be lower than the optimum common voltage (Vcom1) of the second color pixel.

In an exemplary embodiment, the time-dependent change of the color coordinate in the low-gray region may be reduced by setting the capacitance of the parasitic capacitor Cgsa_B between the gate electrode GEa and the drain electrode DEa of the first switching element Qa_B of the first color pixel be greater than the capacitance of the parasitic capacitor Cgsa_G between the gate electrode GEa and the drain electrode DEa of the first switching element Qa_G of the second color pixel, by setting the capacitance of the first storage capacitor Csta_B of the first color pixel be less than the capacitance of the first storage capacitor Csta_G of the second color pixel or by setting the capacitance of the first liquid crystal capacitor Clca_B of the first color pixel be less than the capacitance of the first liquid crystal capacitor Clca_G of the second color pixel.

In such an embodiment, the capacitance of the parasitic capacitor Cgsb_B between the gate electrode GEb and the drain electrode DEb of the second switching element Qb_B of the second sub-pixel PXb_B of the first color pixel may be substantially the same as the capacitance of the parasitic capacitor Cgsb_G between the gate electrode GEb and the drain electrode DEb of the second switching element Qb_G of the second color pixel. In such an embodiment, the capacitance of the second storage capacitor Cstb_B of the first color pixel may be substantially the same as the capacitance of the second storage capacitor Cstb_G of the second color pixel, or the capacitance of the second liquid crystal capacitor Clcb_B of the first color pixel may be substantially the same as the capacitance of the second liquid crystal capacitor Clcb_G of the second color pixel.

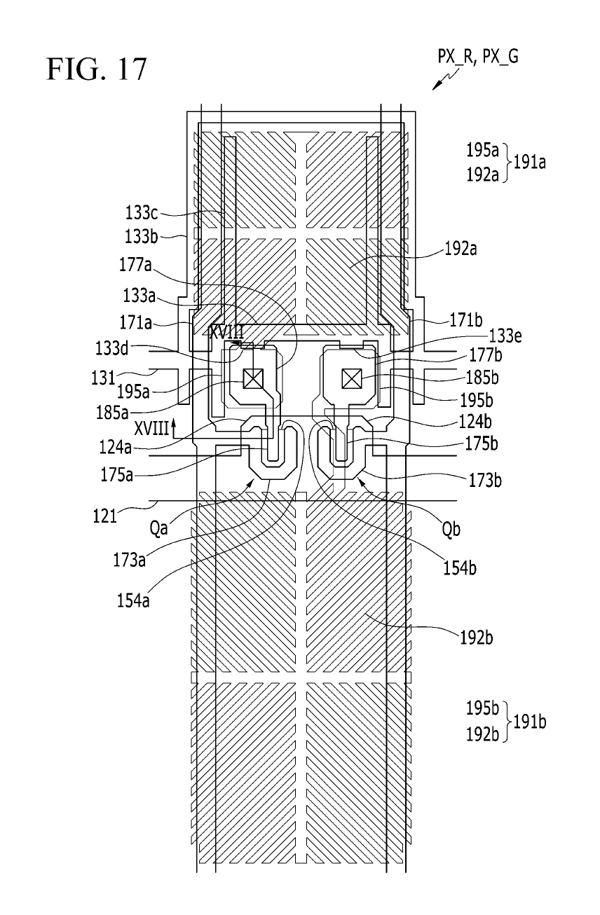

Now, an exemplary embodiment of a display device according to the invention will be described with reference to FIGS. 17 to 19 together with FIGS. 14 to 16.

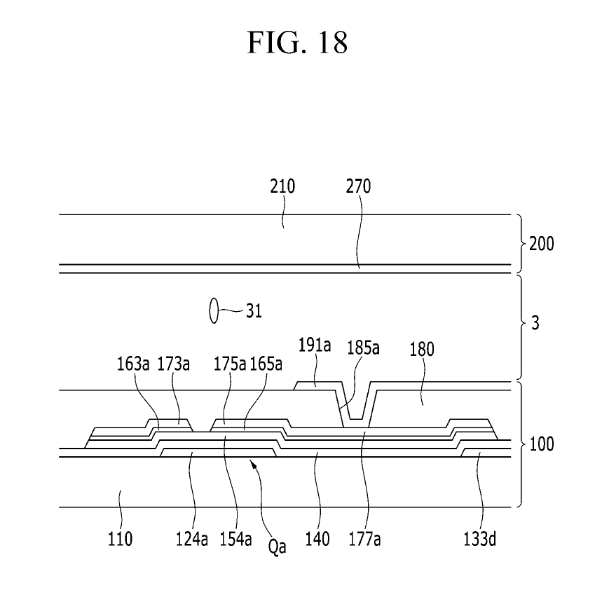

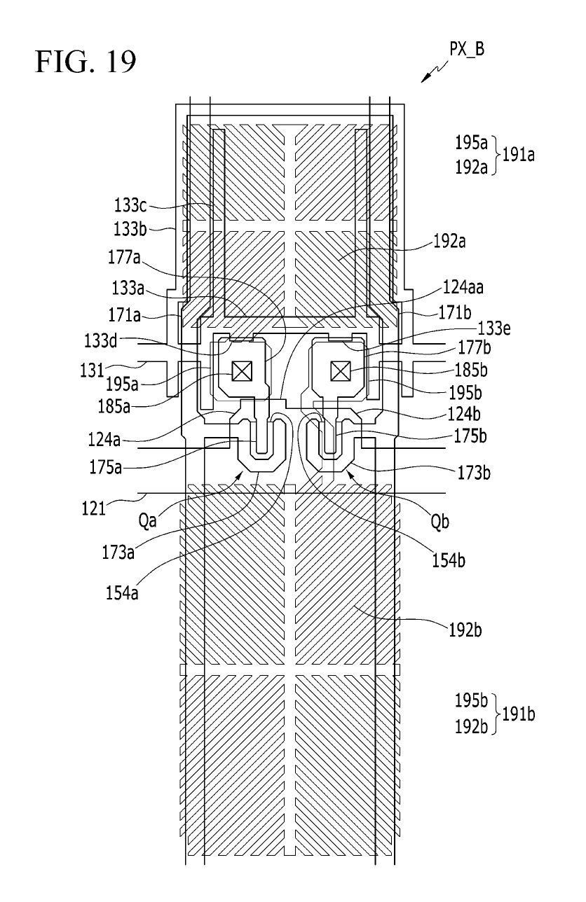

FIG. 17 is a plan view of a pixel displaying a second color in an exemplary embodiment of a display device according to the invention, FIG. 18 is a cross-sectional view taken along line XVIII-XVIII of the display device of FIG. 17, and FIG. 19 is a plan view of a first color pixel in an exemplary embodiment of a display device according to the invention.

Referring to FIGS. 17 to 19, an exemplary embodiment of a display device according to the invention is a liquid crystal display, and includes a lower display substrate 100 and an upper display substrate 200 which face each other, and a liquid crystal layer 3 between the two display substrates 100 and 200.

In such an embodiment, the lower display substrate 100 includes a lower substrate 110, and further includes a gate line 121 and a storage electrode line 131, which are disposed on the lower substrate 110.

The gate line 121 extends substantially in a horizontal direction, and includes a first gate electrode 124a and a second gate electrode 124b.

The storage electrode line 131 may include a horizontal part that extends substantially in a horizontal direction, and a plurality of storage electrodes, e.g., a first storage electrode 133a, a second storage electrode 133b and a third storage electrode 133c, which extend from the horizontal part. The first storage electrode 133a may protrude substantially in an upper direction from the horizontal part of the storage electrode line 131 and then extends in a horizontal direction. The second storage electrode 133b may extend substantially in the upper direction from the horizontal part and then extend in a horizontal direction along an area above the pixel PX_R, PX_G or PX_B. The storage electrode 133c may extend substantially in an upper direction from the storage electrode 133a. The second storage electrode 133b and the third storage electrode 133c may extend substantially parallel to each other. The storage electrode 133a may further include fourth and fifth storage electrodes 133d and 133e protruding therefrom. The fourth storage electrode 133d may overlap an extension portion 177a of a first drain electrode 175a, and the fifth storage electrode 133e may overlap an extension portion 177b of a second drain electrode 175b. However, in an exemplary embodiment, the shapes of the storage electrodes 133a, 133b, 133c, 133d and 133e are not limited to the shapes thereof shown in FIGS. 17 to 23.

A gate insulating film 140 is disposed on the gate line 121 and the storage electrode line 131. A first semiconductor 154a and a second semiconductor 154b are disposed on the gate insulating film 140. The first and second semiconductors 154a and 154b may include crystalline silicon, amorphous silicon, a silicon oxide, or the like, for example.

Ohmic contacts 163a and 165a are disposed on the first and second semiconductors 154a and 154b. The ohmic contacts 163a and 165a may include a material such as n+ hydrogenated amorphous silicon, on which an n-type impurity such as phosphorus is doped at a high concentration, or a silicide. The ohmic contacts 163a and 165a may be disposed as a pair on each semiconductor layer 154a or 154b. In an exemplary embodiment, the semiconductor layers 154a or 154b may include an oxide semiconductor, and the ohmic contacts 163a and 165a may be omitted.

A data conductor is disposed on the ohmic contacts 163a and 165a and the gate insulating film 140. The data conductor includes the first data line 171a, the second data line 171b, the first drain electrode 175a and the second drain electrode 175b.

The first and second data lines 171a and 171b may extend substantially in a vertical direction and substantially parallel to each other. The first and second data lines 171a and 171b include first and second source electrodes 173a and 173b extending toward first and second gate electrodes 124a and 124b, respectively. Each of the first and second data lines 171a and 171b may extend between the second storage electrode 133b and the third storage electrode 133c, which are adjacent to each other.

The first drain electrode 175a may include one end facing the first source electrode 173a and an extension portion 177a having an expanded area for contact with another layer. The second drain electrode 175b may include one end facing the second source electrode 173b and an extension portion 177b having an expanded area for contact with another layer.

The first and second gate electrodes 124a and 124b, the first and second source electrodes 173a and 173b, and the first and second drain electrodes 175a and 175b constitute or collectively define first and second thin film transistors Qa and Qb together with the first and second semiconductors 154a and 154b, respectively. The first switching element Qa_B or Qa_G may include the first thin film transistor Qa, and each of the second switching element Qb_B or Qb_G may include the second thin film transistor Qb.

A passivation film 180 is disposed on the first and second thin film transistors Qa and Qb. Contact holes 185a and 185b for respectively exposing the first and second drain electrodes 175a and 175b are defined or formed in the passivation film 180.

A pixel electrode is disposed on the passivation film 180. The pixel electrode may include a first sub-pixel electrode 191a and a second sub-pixel electrode 191b. The first sub-pixel electrode 191a includes a cross-shaped stem portion, a plurality of branch electrodes 192a extending outwardly from the cross-shaped stem portion, and an extension portion 195a for contact with another layer. Slits are respectively defined or formed between neighboring branch electrodes 192a. The second sub-pixel electrode 191b also includes a cross-shaped stem portion, a plurality of branch electrodes 192b extending outwardly from the cross-shaped stem portion, and an extension portion 195b for contact with another layer. Slits are respectively defined or formed between neighboring branch electrodes 192b.

The first sub-pixel electrode 191a and the second sub-pixel electrode 191b may respectively be disposed opposite to each other with respect to the gate line 121 or arranged above and below the gate line 121 that is interposed therebetween. The area of the first sub-pixel electrode 191a may be smaller than the area of the second sub-pixel electrode 191b.

The first sub-pixel electrode 191a may receive a data voltage from the first drain electrode 175a through the contact hole 185a, and the second sub-pixel electrode 191b may receive a data voltage from the second drain electrode 175b through the contact hole 185b.

The first and second sub-pixel electrodes 191a and 191b may include or be formed of a transparent conductive material such as indium tin oxide (“ITO”), indium zinc oxide (“IZO”), or the like, for example.

In such an embodiment, the display substrate 200 may include an upper substrate, and a counter electrode 270 disposed on the upper substrate 210. The counter electrode 270 may include or be formed of a transparent conductive material such as ITO, IZO, or the like, or a metallic material, for example.

The liquid crystal layer 3 includes liquid crystal molecules 31 having dielectric anisotropy. The liquid crystal molecules 31 may be aligned such that longitudinal axes of the liquid crystal molecules are disposed substantially perpendicular with respect to a surface of the lower and upper display substrates 100 and 200 in the absence of an electric field. The liquid crystal molecules 31 of the liquid crystal layer 3 may be pretilted such that the longitudinal axes of the liquid crystal molecules 31 are disposed substantially parallel to a longitudinal direction of the branch electrodes 192a and 192b of the first and second sub-pixel electrodes 191a and 191b.

The first sub-pixel electrode 191a, the counter electrode 270 and the liquid crystal layer 3 interposed therebetween constitute or collectively define the first liquid crystal capacitor Clca_R, Clca_G or Clca_B. The second sub-pixel electrode 191b, the counter electrode 270 and the liquid crystal layer 3 interposed therebetween constitute or collectively define the second liquid crystal capacitor Clcb_R, Clcb_G or Clcb_B. Here, Clca_R refers to a first liquid crystal capacitor of a red pixel, and Clcb_R refers to a second liquid crystal capacitor of a red pixel.

The first sub-pixel electrode 191a or the first drain electrode 175a connected thereto, and the storage electrode line 131 or the storage electrodes 133a, 133b, 133c, 133d and 133e form or collectively define the first storage capacitor Csta_R, Csta_G or Csta_B, together with an insulating film therebetween. The second sub-pixel electrode 191b or the second drain electrode 175b connected thereto, and the storage electrode line 131 or the storage electrodes 133a, 133b, 133c, 133d and 133e form or collectively define the second storage capacitor Csta_R, Csta_G or Csta_B, together with the insulating film therebetween. Here, Csta_R refers to a first storage capacitor of a red pixel, and Clcb_R refers to a second storage capacitor of a red pixel.

In an exemplary embodiment, referring to FIG. 19, the first gate electrode 124a of the first thin film transistor Qa of the first color pixel, for example, a blue pixel PX_B, may further include an extension portion 124aa overlapping the first drain electrode 175a. Therefore, in such an embodiment, the capacitance of the parasitic capacitor Cgsa_B between the first gate electrode 124a and the first drain electrode 175a of the first thin film transistor Qa of the first color pixel may be greater than the capacitance of the parasitic capacitor Cgsa_R or Cgsa_G between the first gate electrode 124a and the first drain electrode 175a of the first thin film transistor Qa of the second color pixel, for example, a red pixel PX_R or green pixel PX_G. As shown in FIG. 19, the area of the first gate electrode 124a of the first thin film transistor Qa of the first color pixel may be larger than the area of the first gate electrode 124a of the first thin film transistor Qa of the second color pixel.

In such an embodiment, the capacitance of the parasitic capacitor Cgsb_B between the second gate electrode 124b and the second drain electrode 175b of the second thin film transistor Qb of the first color pixel, for example, a blue pixel PX_B, may be substantially the same as the capacitance of the parasitic capacitor Cgsb_R or Cgsb_G of the second thin film transistor Qb of the second color pixel, or may be greater than the capacitance of the parasitic capacitor Cgsb_R or Cgsb_G of the second thin film transistor Qb of the second color pixel.

Therefore, referring back to Equation 1 above, the first and second color pixels are configured to set the kickback voltage of the first color pixel to be greater than the kickback voltage of the second color pixel, such that the optimum common voltage (Vcom2) of the first color pixel may be lower than the optimum common voltage (Vcom1) of the second color pixel.

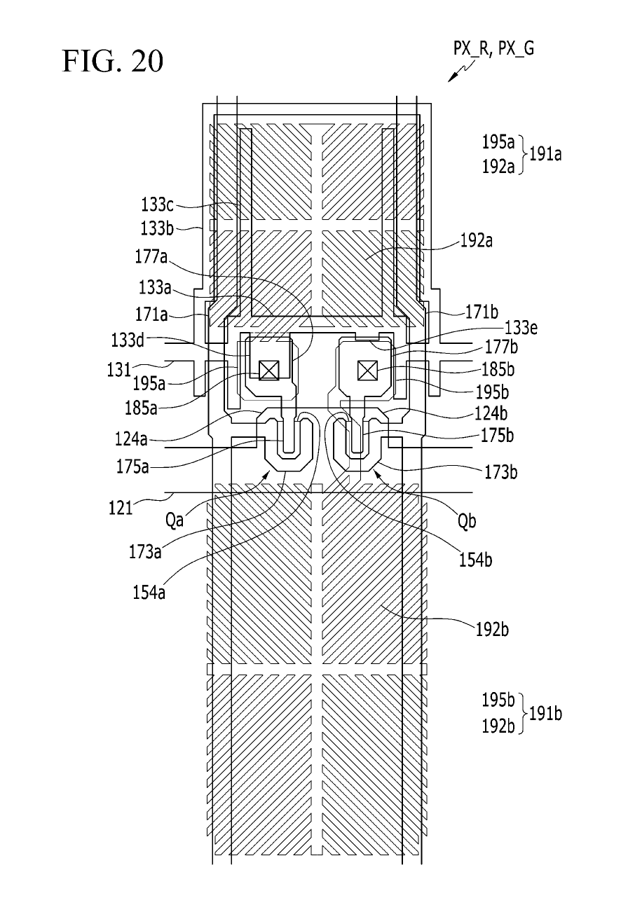

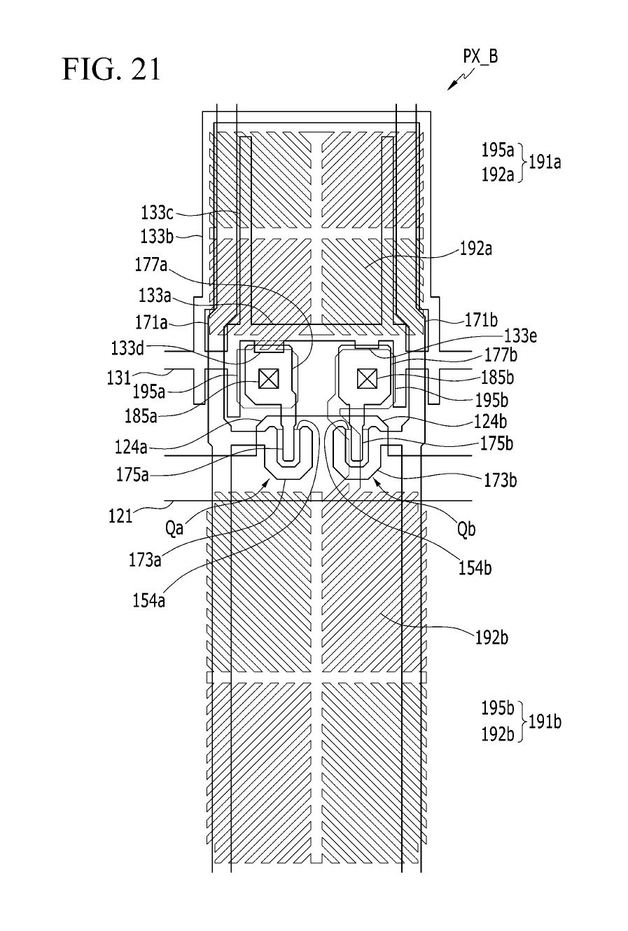

Next, an alternative exemplary embodiment of a display device according to the invention will be described with reference to FIGS. 20 and 21 together with FIGS. 14 to 19.

FIG. 20 is a plan view of a second color pixel in an exemplary embodiment of a display device according to the invention, and FIG. 21 is a plan view of a first color pixel in an exemplary embodiment of a display device according to the invention.

The display device shown in FIGS. 20 and 21 is substantially the same as the display device described above with reference to FIGS. 17 to 19 except for the storage electrode. The same or like elements shown in FIGS. 20 and 21 have been labeled with the same reference characters as used above to describe the exemplary embodiments of the display device shown in FIGS. 17 to 19, and any repetitive detailed description thereof will hereinafter be omitted.

According to an exemplary embodiment, as shown in FIGS. 20 and 21, the area of the fourth storage electrode 133d of the first color pixel, for example, a blue pixel PX_B, may be less than the area of the fourth storage electrode 133d of the second color pixel, for example, a red pixel PX_R or green pixel PX_G, and the overlapping area between the fourth storage electrode 133d and the extension portion 177a of the first drain electrode 175a of the first color pixel, for example, a blue pixel PX_B, is less than the overlapping area between the fourth storage electrode 133d and the extension portion 177a of the first drain electrode 175a of the second color pixel, for example, a red pixel PX_R or green pixel PX_G. Therefore, in such an embodiment, the total capacitance of the first storage capacitor Csta_B of the first color pixel may be less than the total capacitance of the first storage capacitor Csta_R or Csta_G of the second color pixel.

In such an embodiment, the capacitance of the second storage capacitor Cstb_B of the first color pixel may be substantially the same as the capacitance of the second storage capacitor Cstb_R or Cstb_G of the second color pixel, or may be less than the capacitance of the second storage capacitor Cstb_R or Cstb_G of the second color pixel.

Therefore, referring back to Equation 1 above, in such an embodiment, the kickback voltage of the first color pixel is set to be greater than the kickback voltage of the second color pixel, such that the optimum common voltage (Vcom2) of the first color pixel may be lower than the optimum common voltage (Vcom1) of the second color pixel.

In an exemplary embodiment, as shown in FIGS. 20 and 21, the first gate electrode 124a may not include the extension portion 124aa shown in FIG. 19.

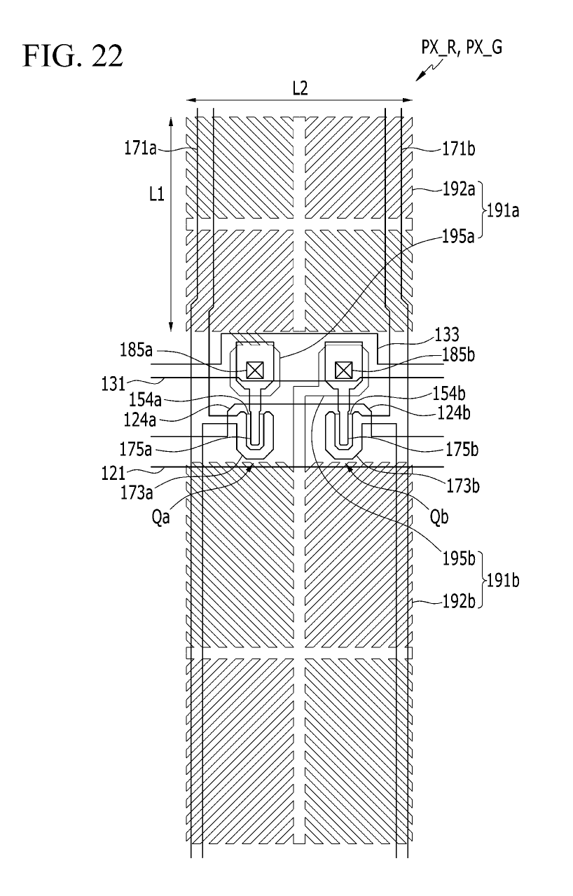

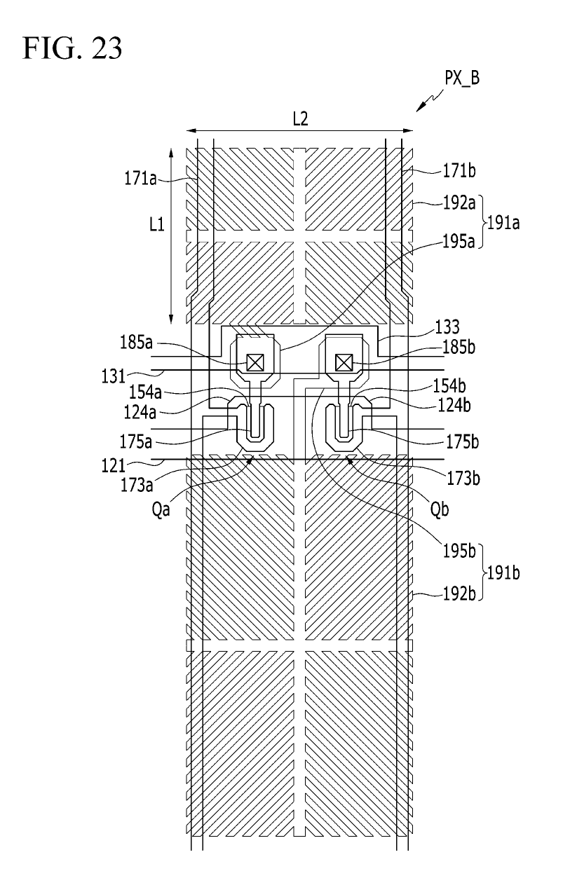

Next, another alternative exemplary embodiment of a display device according to the invention will be described with reference to FIGS. 22 and 23 together with FIGS. 14 to 19.

FIG. 22 is a plan view of a second color pixel in an exemplary embodiment of a display device according to the invention, and FIG. 23 is a plan view of a first color pixel in an exemplary embodiment of a display device according to the invention.

The display device shown in FIGS. 22 and 23 is substantially the same as the display device described above with reference to FIGS. 17 to 19 except for the storage electrode. The same or like elements shown in FIGS. 22 and 23 have been labeled with the same reference characters as used above to describe the exemplary embodiments of the display device shown in FIGS. 17 to 19, and any repetitive detailed description thereof will hereinafter be omitted.

According to an exemplary embodiment, as shown in FIGS. 22 and 23, the area of the first sub-pixel electrode 191a of the first color pixel, for example, a blue pixel PX_B, may be smaller than the area of the first sub-pixel electrode 191a of the second color pixel, for example, a red pixel PX_R or green pixel PX_G. In such an embodiment, the vertical length (L1) and/or the horizontal length (L2) of the first sub-pixel 191a of the first and second pixel may be different from each other. In an exemplary embodiment, as shown in FIGS. 22 and 23, t the vertical length (L1) of the first sub-pixel 191a of the first color pixel may be shorter than the vertical length (L1) of the first sub-pixel electrode 191a of the second color pixel.

Therefore, in such an embodiment, the capacitance of the first liquid crystal capacitor Clca_B of the first color pixel may be smaller than the capacitance of the first liquid crystal capacitor Clca_R or Clca_G of the second color pixel.

In such an embodiment, the capacitance of the second liquid crystal capacitor Clcb_B of the first color pixel may be substantially the same as the capacitance of the second liquid crystal capacitor Clcb_R or Clcb_G of the second color pixel, or may be less than the capacitance of the second liquid crystal capacitor Clcb_R or Clcb_G of the second color pixel.

Therefore, in such an embodiment, referring back to Equation 1 above, the kickback voltage of the first color pixel is set to be greater than the kickback voltage of the second color pixel, such that the optimum common voltage (Vcom2) of the first color pixel may be lower than the optimum common voltage (Vcom1) of the second color pixel.

In an exemplary embodiment, as shown in FIGS. 22 and 23, the first gate electrode 124a may not include the extension portion 124aa shown in FIG. 19. In such an embodiment, as shown in FIGS. 22 and 23, the areas of the fourth storage electrodes 133d of all pixels may be substantially the same as each other.

The storage electrode line 131 may be substantially the same as storage electrode line 131 in the exemplary embodiments described above, and may include a storage electrode 133 overlapping the first drain electrode 175a and the second drain electrode 175b, as shown in FIGS. 22 and 23.

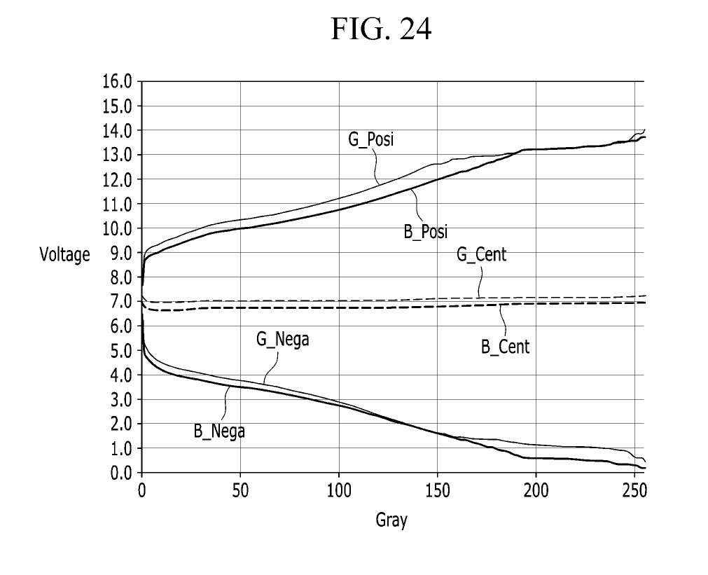

Now, another alternative exemplary embodiment of a display device according to the invention will be described with reference to FIG. 24.

FIG. 24 is a graph showing levels of data voltages depending on grayscale levels while the data voltages are applied to a first color pixel and a second color pixel in an exemplary embodiment of a display device according to the invention.

Referring to FIG. 24, an exemplary embodiment of a display device according to the invention is substantially the same as the exemplary embodiments of the display device described above with reference to FIGS. 17 to 19, FIGS. 20 and 21, or FIGS. 22 and 23.

In such an embodiment, the central value B_Cent of a positive-polarity data voltage B_Posi and a negative-polarity data voltage B_Nega, which are input to the first sub-pixel electrode 191a of the first color pixel, for example, a blue pixel PX_B, may be lower than the central value G_Cent of a positive-polarity data voltage G_Posi and a negative-polarity data voltage G_Nega, which are input to the first sub-pixel electrode 191a of the second color pixel, for example, a green pixel PX_G. Therefore, the optimum common voltage (Vcom2) of the first color pixel may be lower than the optimum common voltage (Vcom1) of the second color pixel.

In such an embodiment, as for a predetermined gray region, e.g., a low-gray region, the positive-polarity data voltage B_Posi input to the first sub-pixel electrode 191a of the first color pixel may be lower than the positive-polarity data voltage G_Posi input to the first sub-pixel electrode 191a of the second color pixel, and the negative-polarity data voltage B_Nega input to the first sub-pixel electrode 191a of the second color pixel may be lower than the negative-polarity data voltage G_Nega input to the first sub-pixel electrode 191a of the second color pixel.

In such an embodiment, the central value of the positive-polarity data voltage and the negative-polarity data voltage, which are input to the second sub-pixel electrode 191b of the first color pixel, may be substantially the same as or lower than the central value of the positive-polarity data voltage and the negative-polarity data voltage, which are input to the second sub-pixel electrode 191b of the second color pixel.

In such an embodiment shown in FIG. 24, the first gate electrode 124a may not include the extension portion 124aa shown in FIG. 19. In such an embodiment, the areas of the fourth storage electrodes 133d of all pixels may be substantially the same as each other. In such an embodiment, the area of the first sub-pixel electrode 191a of the first color pixel may be substantially the same as the area of the first sub-pixel electrode 191a of the second color pixel.

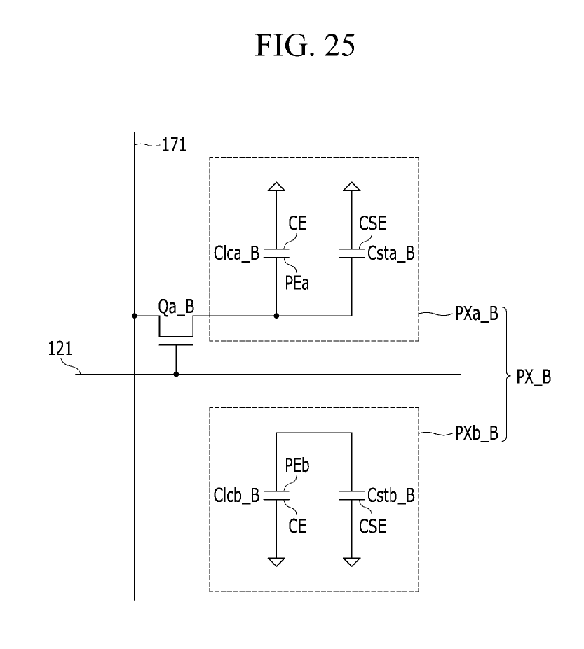

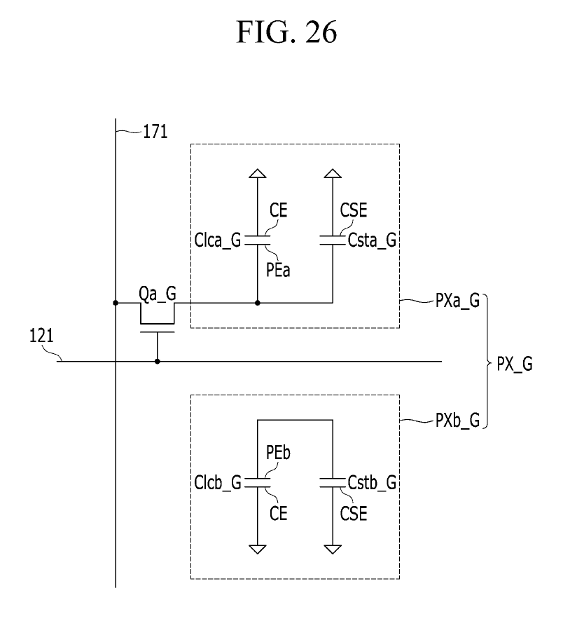

Next, another alternative exemplary embodiment of a display device according to the invention will be described with reference to FIGS. 25 and 26, together with the foregoing drawings.

FIG. 25 is a schematic circuit diagram of a first color pixel in an exemplary embodiment of a display device according to the invention, and FIG. 26 is a schematic circuit diagram of a second color pixel in an exemplary embodiment of a display device according to the invention.

A first color pixel, for example, a blue pixel PX_B, and a second color pixel, for example, a green pixel PX_G, of the display device shown in FIGS. 25 and 26 are substantially the same as those in the exemplary embodiment shown in FIGS. 14 and 15, and any repetitive detailed description thereof will hereinafter be omitted or simplified.

In an exemplary embodiment, as shown in FIGS. 25 and 26, a display device may include a data line 171 that transmits a data voltage and a gate line 121 that transmits a gate signal.

Referring to FIG. 25, in such an embodiment, a first sub-pixel PXa_B of the first color pixel, for example, a blue pixel PX_B, may include a first switching element Qa_B connected to the gate line 121 and the data line 171, a first liquid crystal capacitor Clca_B connected to the first switching element Qa_B, and a first storage capacitor Csta_B. The first liquid crystal capacitor Clca_B of the first sub-pixel PXa_B of the first color pixel includes a first sub-pixel electrode PEa and a counter electrode CE as two terminals. The first liquid crystal capacitor Csta_B of the first sub-pixel PXa_B of the first color pixel includes the first sub-pixel electrode PEa or the drain electrode of the first switching element Qa_B and a storage electrode CSE as two terminals.

In such an embodiment, a second sub-pixel PXb_B of the first color pixel, for example, a blue pixel PX_B, may include a second liquid crystal capacitor Clcb_B and a second storage capacitor Cstb_B, which are connected to each other. The second liquid crystal capacitor Clcb_B of the second sub-pixel PXb_B of the first color pixel includes a second sub-pixel electrode PEb and the counter electrode CE as two terminals. The second storage capacitor Cstb_B of the second sub-pixel PXb_B of the first color pixel includes the second sub-pixel electrode PEb or an electrode connected thereto and the storage electrode CSE as two terminals.

The second liquid crystal capacitor Clcb_B of the second sub-pixel PXb_B of the first color pixel may be charged with a voltage, which is different from the charging voltage of the first liquid crystal capacitor Clca_B of the first sub-pixel PXa_B of the first color pixel, through various electronic elements, such as a thin film transistor or a capacitor. The second liquid crystal capacitor Clcb_B may such a structure to be charged with a different voltage from the first liquid crystal capacitor Clca_B of the first sub-pixel PXa_B through several conventional units or elements known in the art, such as a coupling capacitor and the like, and any detailed descriptions thereof will be omitted.

Referring to FIG. 26, a first sub-pixel PXa_G of the second color pixel, for example, a green pixel PX_G, may include a first switching element Qa_G connected to a gate line 121 and a data line 171, a first liquid crystal capacitor Clca_G connected to the first switching element Qa_G, and a first storage capacitor Csta_G. The first liquid crystal capacitor Clca_G of the first sub-pixel PXa_G of the second color pixel includes a first sub-pixel electrode PEa and a counter electrode CE as two terminals. The first storage capacitor Csta_G of the first sub-pixel PXa_G of the second color pixel includes the first sub-pixel electrode PEa or the drain electrode of the first switching element Qa_G and a storage electrode CSE as two terminals.

The second sub-pixel PXb_G of the second color pixel, for example, a green pixel PX_G, may include a second liquid crystal capacitor Clcb_G and a second storage capacitor Cstb_G, which are connected to each other. The second liquid crystal capacitor Clcb_G of the second sub-pixel PXb_G of the second color pixel includes a second sub-pixel electrode PEb and the counter electrode CE as two terminals. The second storage capacitor Cstb_G of the second sub-pixel PXb_G of the second color pixel includes the second sub-pixel electrode PEb or an electrode connected thereto and the storage electrode CSE as two terminals.

The second liquid crystal capacitor Clcb_G of the second sub-pixel PXb_G of the second color pixel includes may be charged with a voltage which is different from the charging voltage of the first liquid crystal capacitor Clca_G of the first sub-pixel PXa_G of the second color pixel, through various electronic elements, such as a thin film transistor or a capacitor.

In an exemplary embodiment, the second color pixel may be a red pixel PX_R, and may have a structure shown in FIG. 26.

Referring to FIGS. 25 and 26, in such an embodiment, the kickback voltage of the first color pixel, e.g., the first sub-pixel PXa_B of the first color pixel, may be different from the kickback voltage of the second color pixel, e.g., the first sub-pixel PXa_G of the second color pixel such that the optimum common voltage (Vcom2) of the first color pixel may be set to be different from the optimum common voltage (Vcom1) of the second color pixel. In an exemplary embodiment, the kickback voltage of the first sub-pixel PXa_B of the first color pixel may be greater than the kickback voltage of the first sub-pixel PXa_G of the second color pixel, such that the optimum common voltage (Vcom2) of the first color pixel can be lower than the optimum common voltage (Vcom1) of the second color pixel, as described above.

In such an embodiment, the central value B_Cent of a positive-polarity data voltage B_Posi and a negative-polarity data voltage B_Nega, which are input to the first sub-pixel electrode 191a of the first color pixel, for example, a blue pixel PX_B, may be set to be lower than the central value G_Cent of a positive-polarity data voltage G_Posi and a negative-polarity data voltage G_Nega, which are input to the first sub-pixel electrode 191a of the second color pixel, for example, a green pixel PX_G, as shown in FIG. 24, such that the optimum common voltage (Vcom2) of the first color pixel may be lower than the optimum common voltage (Vcom1) of the second pixel, as described above.

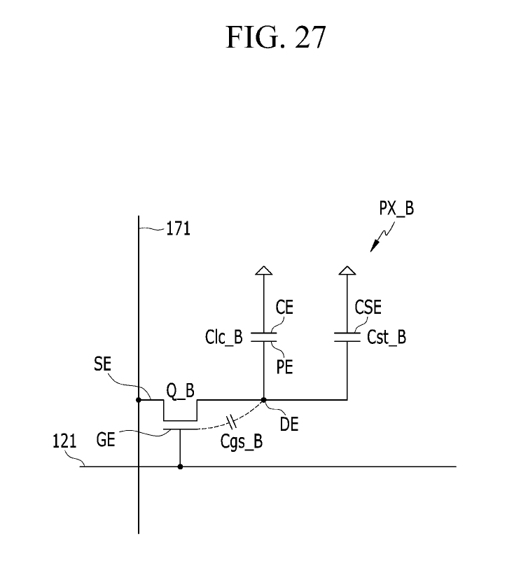

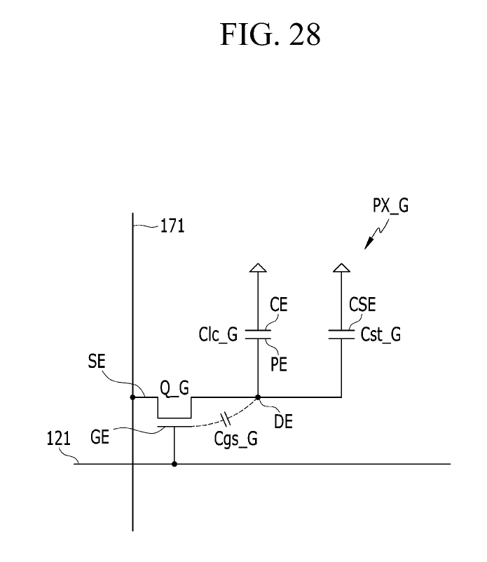

Hereinafter, another alternative exemplary embodiment of a display device according to the invention will be described with reference to FIGS. 27 and 28, together with the foregoing drawings.

FIG. 27 is a schematic circuit diagram of a first color pixel in an exemplary embodiment of a display device according to the invention, and FIG. 28 is a schematic circuit diagram of a second color pixel in an exemplary embodiment of a display device according to the invention.

Referring to FIGS. 27 and 28, a first color pixel, for example, a blue pixel PX_B, and a second color pixel, for example, a green pixel PX_G of such an embodiment are substantially the same as those in the exemplary embodiments described above, except that each pixel does not include a plurality of sub-pixels.

Referring to FIG. 27, the first color pixel, for example, a blue pixel PX_B, may include a switching element Q_B including a gate electrode GE connected to a gate line 121, a source electrode SE connected to a data line 171, and a drain electrode DE, a liquid crystal capacitor Clc_B connected to the drain electrode DE of the switching element Q_B, and a storage capacitor Cst_B. The liquid crystal capacitor Clc_B of the first color pixel includes a pixel electrode PE and a counter electrode CE as two terminals. The storage capacitor Cst_B of the first color pixel includes a pixel electrode PE or the drain electrode of the switching element Q_B and a storage electrode CSE as two terminals.

The gate electrode GE and the drain electrode DE of the switching element Q_B of the first color pixel may collectively define or form a parasitic capacitor Cgs B.

Referring to FIG. 28, the second color pixel, for example, a green pixel PX_G, may include a switching element Q_G including a gate electrode GE connected to a gate line 121, a source electrode SE connected to a data line 171, and a drain electrode DE, a liquid crystal capacitor Clc_G connected to the drain electrode DE of the switching element Q_G, and a storage capacitor Cst_G. The liquid crystal capacitor Clc_G of the second color pixel includes a pixel electrode PE and a counter electrode CE as two terminals. The storage capacitor Cst_G of the second color pixel includes a pixel electrode PE or the drain electrode DE of the switching element Q_G and a storage electrode CSE as two terminals.

The gate electrode GE and the drain electrode DE of the switching element Q_G of the second color pixel may collectively define or form a parasitic capacitor Cgs_G.

Referring to FIGS. 27 and 28, to set the optimum common voltage (Vcom2) of the first color pixel to be different from the optimum common voltage (Vcom1)) of the second color pixel, the kickback voltage of the first color pixel may be set to be different from the kickback voltage of the second color pixel. In such an embodiment, the kickback voltage of the first color pixel may be greater than the kickback voltage of the second color pixel, such that the optimum common voltage (Vcom2) of the first color pixel may be lower than the optimum common voltage (Vcom1)) of the second color pixel. In such an embodiment, characteristics of the first and second pixels may be substantially the same as the first sub-pixels in the first and second pixels of the exemplary embodiments described above, and any repetitive detailed description thereof will be omitted.

In such an embodiment, as in the exemplary embodiment, the central value of a positive-polarity data voltage and a negative-polarity data voltage, which are input to the pixel electrode PE of the first color pixel, for example, a blue pixel PX_B, may be set to be lower than the central value of a positive-polarity data voltage and a negative-polarity data voltage, which are input to the pixel electrode of the second color pixel, for example, a green pixel PX_G, as shown in FIG. 24, such that the optimum common voltage (Vcom2) of the first color pixel may be lower than the optimum common voltage (Vcom1)) of the second pixel as described above.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device comprising:
a plurality of gate lines which transmits a gate signal;
a plurality of data lines which transmits a positive-polarity data voltage and a negative-polarity data voltage;
a first color pixel comprising:
a first switching element connected to the gate line and the data line; and
a first capacitor connected to the first switching element, wherein the first color pixel displays a first color; and
a second color pixel comprising:
a second switching element connected to the gate line and the data line; and
a second capacitor connected to the second switching element, wherein the second color pixel displays a second color different from the first color,
wherein an optimum common voltage of the first color pixel is lower than an optimum common voltage of the second color pixel.

2. The display device of claim 1, wherein
a first kickback voltage of the first color pixel is greater than a second kickback voltage of the second color pixel.

3. The display device of claim 2, wherein
a capacitance of a first parasitic capacitor between a drain electrode and a gate electrode of the first switching element is greater than a capacitance of a second parasitic capacitor between a drain electrode and a gate electrode of the second switching element.

4. The display device of claim 3, wherein
an area of the gate electrode of the first switching element is larger than an area of the gate electrode of the second switching element.

5. The display device of claim 2, wherein
the first capacitor comprises:
a first liquid crystal capacitor comprising a first pixel electrode connected to a drain electrode of the first switching element and a counter electrode, as two terminals thereof; and
a first storage capacitor comprising the first pixel electrode or the drain electrode of the first switching element, and a first storage electrode, as two terminals thereof, and
the second capacitor comprises:
a second liquid crystal capacitor comprising a second pixel electrode connected to a drain electrode of the second switching element and a counter electrode as two terminals thereof; and
a second storage capacitor comprising the second pixel electrode or the drain electrode of the second switching element, and a second storage electrode, as two terminals thereof.

6. The display device of claim 5, wherein
a capacitance of the first storage capacitor is less than a capacitance of the second storage capacitor.

7. The display device of claim 5, wherein
a capacitance of the first liquid crystal capacitor is less than a capacitance of the second liquid crystal capacitor.

8. The display device of claim 1, wherein
a first central value of the positive-polarity data voltage and the negative-polarity data voltage, which are input to the first color pixel, is lower than a second central value of the positive-polarity data voltage and the negative-polarity data voltage, which are input to the second color pixel.

9. The display device of claim 1, wherein
the first color is a blue color.

10. The display device of claim 1, wherein
each of the first color pixel and the second color pixel comprises a first sub-pixel and a second sub-pixel, which display an image based on different gamma curves from each other,
the first sub-pixel of the first color pixel comprises the first switching element,
the first sub-pixel of the second color pixel comprises the second switching element, and
an optimum common voltage of the first sub-pixel of the first color pixel is lower than an optimum common voltage of the first sub-pixel of the second color pixel.

11. The display device of claim 10, wherein
a first kickback voltage of the first sub-pixel of the first color pixel is greater than a second kickback voltage of the first sub-pixel of the second color pixel.

12. The display device of claim 11, wherein
a capacitance of a first parasitic capacitor between a drain electrode and a gate electrode of the first switching element is greater than a capacitance of a second parasitic capacitor between a drain electrode and a gate electrode of the second switching element.

13. The display device of claim 12, wherein
an area of the gate electrode of the first switching element is larger than an area of the gate electrode of the second switching element.

14. The display device of claim 11, wherein
the first capacitor comprises:
a first liquid crystal capacitor comprising a first sub-pixel electrode connected to a drain electrode of the first switching element and a counter electrode, as two terminals thereof; and
a first storage capacitor comprising the first sub-pixel electrode or the drain electrode of the first switching element, and a first storage electrode, as two terminals thereof, and
the second capacitor comprises:
a second liquid crystal capacitor comprising a second sub-pixel electrode connected to a drain electrode of the second switching element and a counter electrode, as two terminals thereof; and
a second storage capacitor comprising the second sub-pixel electrode or the drain electrode of the second switching element, and a second storage electrode, as two terminals thereof.

15. The display device of claim 14, wherein
a capacitance of the first storage capacitor is less than a capacitance of the second storage capacitor.

16. The display device of claim 14, wherein
a capacitance of the first liquid crystal capacitor is less than a capacitance of the second liquid crystal capacitor.

17. The display device of claim 10, wherein
a first central value of the positive-polarity data voltage and the negative-polarity data voltage, which are input to the first sub-pixel of the first color pixel, is lower than a second central value of the positive-polarity data voltage and the negative-polarity data voltage, which are input to the first sub-pixel of the second color pixel.

18. The display device of claim 10, wherein
a common voltage applied to the first color pixel and the second color pixel is substantially constant.

19. A driving method of a display device, the method comprising:
turning on a first switching element in a first color pixel of the display device to charge a first capacitor in the first color pixel, wherein the first color pixel displays a first color and the first capacitor is connected to the first switching element;
turning on a second switching element in a second color pixel of the display device to charge a second capacitor in the second color pixel, wherein the second color pixel displays a second color different from the first color, and the second capacitor is connected to the second switching element;
turning off the first switching element to drop a voltage of a first pixel electrode in the first color pixel by a first kickback voltage; and
turning off the second switching element to drop a voltage of a second pixel electrode in the second color pixel by a second kickback voltage,
wherein the first kickback voltage is greater than the second kickback voltage.

20. A driving method of a display device, the method comprising:
applying a positive-polarity data voltage and a negative-polarity data voltage to a first color pixel of the display device through a first switching element in the first color pixel while the first switching element is turned on; and
applying a positive-polarity data voltage and a negative-polarity data voltage to a second color pixel of the display device through a second switching element in the second color pixel while the second switching element is turned on,
wherein a first central value of the positive-polarity data voltage and the negative-polarity data voltage, which are input to the first color pixel, is lower than a second central value of the positive-polarity data voltage and the negative-polarity data voltage, which are input to the second color pixel.
